(19) United States
(12) Patent Application Publication
(10) Pub. No.: US 2007/0049098 A1
(43) Pub. Date: Mar. 1, 2007

(54) Optical connector

(76) Inventors: Richard E. Feinbloom, New York, NY (US); Kenneth Braganca, Floral Park, NY (US); Matthew Kenyon, Nesconset, NY (US)

Correspondence Address: PLEVY & HOWARD & DARCY P.C., P.O. BOX 226, Fort Washington, PA, 19034, US

(21) Appl. No.: 11/212,040

(22) Filed: Aug. 25, 2005

(51) Int. Cl. H01R 13/627

(52) U.S. Cl. 439/349

(57) ABSTRACT

An optical connector for connecting an optical cable having a cylindrical endpiece to a light source has a structure having an interior bore with a longitudinal axis, a port for receiving an illuminating beam and another port for receiving the cylindrical endpiece. A channel is defined along the periphery of the bore in the structure. A generally circular shaped spring member is positioned in the channel. The inner diameter of the circular shape is slightly smaller than the outer diameter of the cylindrical endpiece, which allows the establishment of a secure, yet releasable, connection between the cylindrical endpiece and the spring member. If the person wearing the headset connected to the optical cable moves too far, the optical cable is released from the housing.

### FIELD OF THE INVENTION

The present invention relates to an optical connector, and more particularly to a connector between an optical cable and a light source.

### BACKGROUND OF THE INVENTION

The use of illuminating headsets connected to a light source is well-known in the art. For example, a conventional apparatus includes a light source contained in a housing. Such an apparatus is placed on a convenient table or shelf. An illuminating headset is connected to the apparatus. Dentists and other dental professionals, among others, have been using such illuminating headsets.

The housing also includes an elliptical reflector or a lens arrangement which focuses the light on an output in the housing. A cylindrical endpiece of a flexible optical cable is connected to the output end. At the other end of the optical cable is the illuminating headset. The headset also has a focusing lens arrangement and provides illumination of a work area.

In the prior art, the connection between the light source and the illuminating headset has been problematic. The conventional connection between the cylindrical endpiece of the flexible optical cable and the housing output locks the cable to the housing. If a person wearing the headset moves too far, the optical cable is drawn taut and the housing may be pulled off its resting surface. As a result the light source is likely to be damaged. If the light source apparatus is heavy enough to resist the pull, the person wearing the headset will experience a force on her head and neck, pulling her back.

Thus there is a need for a mechanism which can prevent potential damage to a light source as well as potential injury to a person wearing the illuminating headsets. Since there is a large base of headsets with attached optical cables and cylindrical endpieces, the modification of the cylindrical endpiece is not a feasible solution.

### SUMMARY OF THE INVENTION

An optical connector for connecting an optical cable having a cylindrical endpiece of a given outer diameter to a light source includes a structure with an interior bore along a longitudinal axis. The bore has a port for receiving an illuminating beam at a proximal end. A channel is defined within the structure centered on and transverse to the longitudinal axis. The structure is adapted to receive the cylindrical endpiece of the optical cable at a second port at a distal end.

The optical connector further includes a spring member. The spring member is positioned, in a circular shape, in the channel. The inner diameter of the circular shape of the spring member is slightly smaller than the outer diameter of the cylindrical endpiece of the optical cable. This arrangement allows a secure, yet releasable, connection between the cylindrical endpiece of the optical cable and the spring member in the structure, when the cylindrical endpiece is inserted into the structure.

In one embodiment of the invention, the bore may have a cylindrical inner surface. The channel may be defined in the cylindrical inner surface of the bore.

In one embodiment, the spring member may be a compression coil spring.

In another embodiment, the spring member may be substantially cylindrical and may be made of elastomeric material.

Another aspect of the invention is a method of connecting an optical cable having a generally cylindrical endpiece, having a given outer diameter, to a light source. The method includes providing a structure with an interior bore along a longitudinal axis and having a first port for receiving an illuminating beam at a proximal end and having a second port for receiving a cylindrical endpiece at a distal end. The method also includes a further step of defining a channel in the structure along at least a portion of the interior bore, transverse to the longitudinal axis and along the periphery of the interior bore. The method further includes a step of providing a spring member capable of having a circular shape. The inner diameter of the circular shape is slightly smaller than the outer diameter of the cylindrical endpiece of the optical cable. One of the steps is positioning the spring member in the channel. The method also includes a step of inserting the cylindrical endpiece of the optical cable in the other end of the structure until the endpiece establishes a substantially secure, yet releasable, connection with the spring member.

In a preferred embodiment, the spring member may be a compression coil spring.

In another embodiment, the spring member may be substantially cylindrical and may be made of an elastomeric material.

Another aspect of the invention is a method of connecting the cylindrical endpiece of the optical cable to a light source which further includes the step of inserting the cylindrical endpiece until the endpiece contacts the spring member, and applying further force to urge a leading edge of the endpiece past the spring member. On application of the force, the endpiece travels until the leading edge engages a stop in the structure and an opening in the cylindrical endpiece is in alignment with the port which receives an illuminating beam.

### BRIEF DESCRIPTION OF THE FIGURES

The advantages, nature, and various additional features of the invention will appear more fully upon consideration of the illustrative embodiments now to be described in detail in connection with accompanying drawings where like reference numerals identify like elements throughout the drawings:

FIG. 1A is an isometric view of an exemplary light source connected to an illuminating headset via a flexible optical cable, employing an optical connector in accordance with an embodiment of the invention.

FIG. 1B is a schematic view of the light source and illuminating headset of FIG. 1A.

FIG. 2 is a front view of a connector in accordance with an embodiment of the invention showing the structure and the spring member;

FIG. 3 is a section taken along line 3-3 of a connector of FIG. 2 showing the structure and the spring member.

FIG. 4 is a front view of a connector in accordance with an embodiment of the invention particularly suited for an optical connector provided with a collar;

FIG. 5 is a section taken along line 5-5 of FIG. 4.

FIG. 6 is a front view showing an exemplary endpiece inserted in the connector of FIG. 4; and

FIG. 7 is a section taken along line 7-7 of FIG. 6.

### DETAILED DESCRIPTION

It is to be understood that the figures and descriptions of the present invention have been simplified to illustrate elements that are relevant for a clear understanding of the present invention, while eliminating, for purposes of clarity, many other elements found in typical illuminating systems. However, because such elements are well known in the art, and because they do not facilitate a better understanding of the present invention, a discussion of such elements is not provided herein. The disclosure herein is directed to all such variations and modifications known to those skilled in the art.

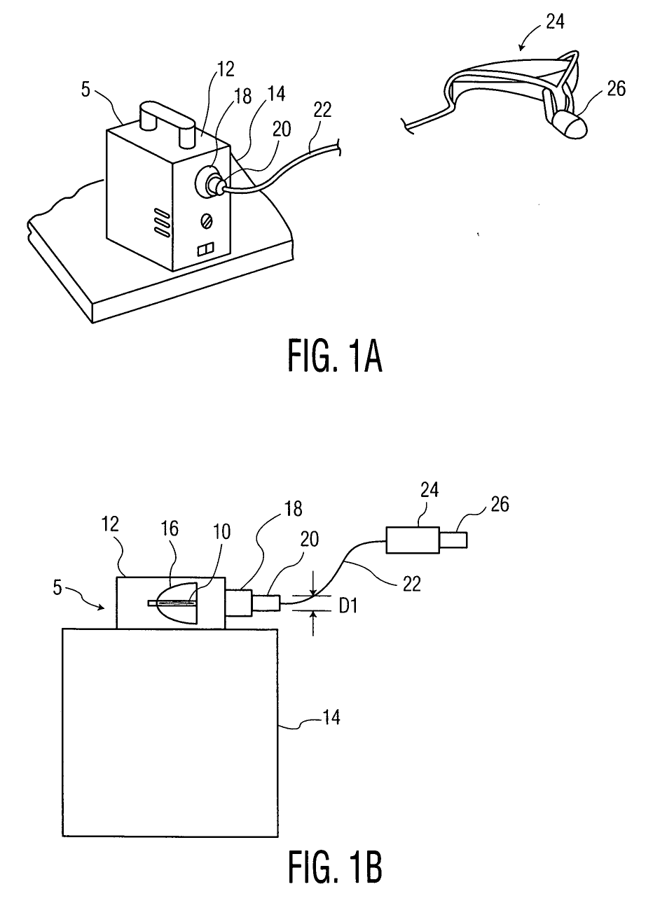

Referring to FIGS. 1A and 1B, an optical connector in accordance with an embodiment of the invention is illustrated as incorporated in an illuminating system. An exemplary light source 5 is shown disposed on a support 14, which may be a table, cabinet or other suitable structure. As shown schematically in FIG. 1B, the light source 5 may include, among other components, a light bulb 10 and an elliptical reflector 16 in a housing 12. A lens arrangement may be provided as an alternative to elliptical reflector 16. An optical connector 18 is connected to the housing 12. An optical cable 22 having a cylindrical endpiece 20 at one end is connected to the housing 12 through the optical connector 18. The cylindrical endpiece 20 has a given outer diameter D1. On the other end of the optical cable 22 is an illuminating headset 24. A focusing arrangement 26 is provided in the headset 24.

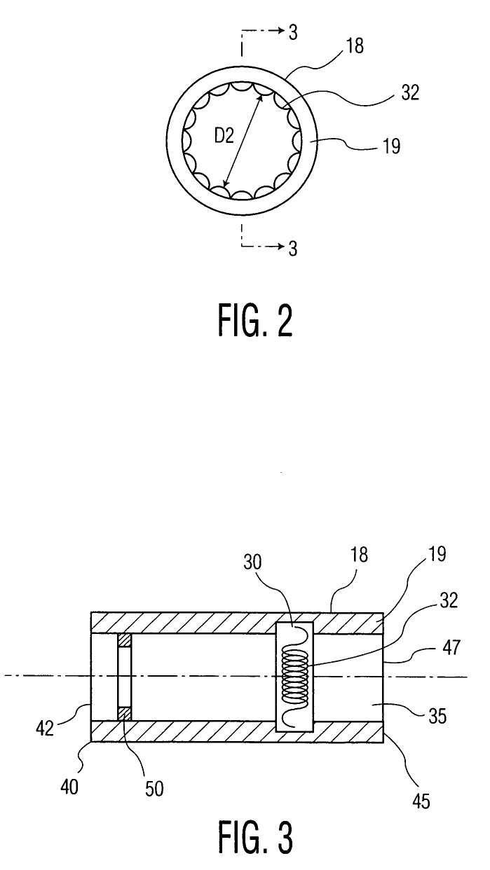

An embodiment of the optical connector 18 is illustrated in FIGS. 2 and 3. The connector 18 includes a structure 19, having a channel 30 defined therein, and a spring member 32. As an exemplary illustration only, the structure 19 is a cylindrical structure having an interior bore 35 along a longitudinal axis, indicated by a dash-dot line in FIG. 3. The longitudinal axis may be aligned with a path of an illuminating beam that emerges from bulb 10 and elliptical reflector 16 and passes through an opening or transparent window in housing 12. Structure 19 may be provided in shapes other than cylindrical. The interior bore 35 has a first port 42 at a proximal end 40 thereof and a second port 47 at a distal end 45 thereof. In the illustrated embodiment, the first port 42 at the proximal end 40 is adapted to receive an illuminating beam from the light bulb 10 and elliptical reflector 16. First port 42 may be an opening, or may include a transparent window, for example. In the illustrated embodiment, the second port 47 at the distal end 45 is of a shape and size such as to receive the cylindrical endpiece 20 of the optical cable 22. The structure 19 may include a stop 50 for preventing the endpiece 20 from moving further in the proximal direction.

The channel 30 is situated in the structure 19, and may be defined in the periphery of the interior bore 35. The spring member 32 is positioned in channel 30. While the interior bore 35 may have a cylindrical inner surface, it will be apparent to one skilled in the art that the interior bore need not have a cylindrical inner surface, as long as it can accommodate the cylindrical endpiece 20 of the optical cable 22. Preferably, bore 35 has a surface that serves to guide a cylindrical endpiece 20 inserted in port 47 to be centered on and aligned with the illuminating beam. As the beam is aligned with the longitudinal axis, bore 35 should guide endpiece 20 to be centered on and aligned with the longitudinal axis. Similarly, the channel 30 need not be defined in the periphery of bore 35; channel 30 may be defined by a separate element such as a washer with a concave interior surface mounted within structure 19 transverse to and centered on the longitudinal axis. The channel 30 holds and positions the spring member 32. Other mechanisms like braces and clamps may also be used to hold the spring member 32 in a circular shape. Two or more channels 30 may also be provided in a structure 19 without departing from the scope of the invention.

The spring member 32 is capable of assuming a circular shape. The circular shape of the spring member 32, when not under an expanding force, has an inner diameter D2, which is slightly smaller than the outer diameter D1 of the cylindrical endpiece 20. As an exemplary embodiment only, the spring member 32 is a compression coil spring. The spring member 32 may also be made of suitable elastomeric material and may be substantially cylindrical. Two or more spring members 32 may be positioned inside a structure 19.

When the cylindrical endpiece 20 is inserted in the structure 19, of the optical connector 18, a leading edge of the endpiece 20 is urged inward until the leading edge of endpiece 20 contacts the spring member 32. Further movement of endpiece 20 requires expansion of the spring member 32 around endpiece 20 and further into 30. At this point, the user will generally need to apply increasing force on the endpiece 20 until the spring member 32 has been expanded sufficiently to permit the endpiece 20 to move past the spring member 32. As the counter force exerted by the endpiece 20 to the user abruptly decreases when the spring member 32 is expanded sufficiently to permit endpiece 20 to move past, and the user typically continues applying the same magnitude of force, the endpiece 20 is moved forward relatively quickly until reaching a fully inserted position, which may be designed by stop 50 or by a collar on endpiece 20, as illustrated in FIG. 7. This provides for endpiece 20 to be properly positioned relatively close to the source of the illuminating beam. Since the inner diameter D2 of the spring member 32 is slightly smaller than the outer diameter D1 of the endpiece 18, a secure operative, yet releasable, connection is established between the connector structure 18 and the cylindrical endpiece 18. The connection thus established is secure in the sense that application of force below a threshold on the optical cable 22 will not overcome the force applied by spring member 32 on endpiece 20, and endpiece 20 will remain in position. The connection is operative because the endpiece 20 is aligned with the proximal end 45 of the structure 19 and thus is capable of receiving the illuminating beam from the light bulb 10. If a force greater than the threshold is applied on the optical cable 22, as explained below, or on endpiece 20, the endpiece 20 will be released from the structure 19, which renders the connection releasable. Once this connection is established, the light emitted by the light bulb 10 passes from lamp 10 and elliptical reflector 16, into the proximal end 40 of the structure 19, through the cylindrical endpiece 20 at the distal end 45, via the interior bore 35. The light then passes through the optical cable 22 to the lens arrangement 26 of the illuminating headset 24.

If a person wearing the illuminating headset 26 moves too far, the optical cable 22 is drawn taut and a pulling force is exerted on endpiece 20. While the force level is below a threshold, the spring member 32 will prevent the endpiece 20 from moving. The threshold level may be selected by one of ordinary skill by selection of the properties of the spring member 32, and the dimensions of the channel 30. As a non-limiting example for illustrative purposes only, a suitable spring member 32 may have following specifications:

| Material: | 316 Stainless Steel |
|---|---|
| Inner Diameter: | 0.312″ |
| Outer Diameter: | 0.450″ |
| Compression: | 17% |
| Coil Width: | 0.100″ |
| Coil Height″ | 0.069″ |

Such a spring member 32 may be positioned in a channel 30 having a depth of about 0.46 inches and a width of about 0.1 inches. The threshold level may also be adjustably selected by positioning two or more spring members in an optical connector. Once the force level exceeds the threshold, the endpiece 20 will begin to move toward the distal end 45 of the structure 19. As the endpiece moves, the friction generated between the spring member 32 and the endpiece 20 will resist the pulling force. If the pulling force continues to be applied, the endpiece 20 will continue to slide until its leading edge has cleared spring member 32, at which point the endpiece 20 will be no longer be retained in optical connector 18. The connection may also be released intentionally by pulling the endpiece 20 firmly out of the connector 18.

An exemplary advantage of such a releasable connection is that upon application of a sufficient pulling force on the optical cable 22, such as a force resulting from a person wearing the illuminating headset 26 moving too far from the light source 5, the spring member 32 releases the endpiece 20, and the optical cable 22, and prevents either the light source 5 being pulled off the support 14 or the counter force of the light source resisting movement of the headset and exerting force on the wearer's head, possibly causing the head to be pulled sharply toward the light source. Such a connection also promotes full insertion of endpiece 20 for proper alignment of endpiece 20 into the path of the illuminating beam emitted by the light bulb 10, as well as minimizing scattering of the beam prior to entering endpiece 20.

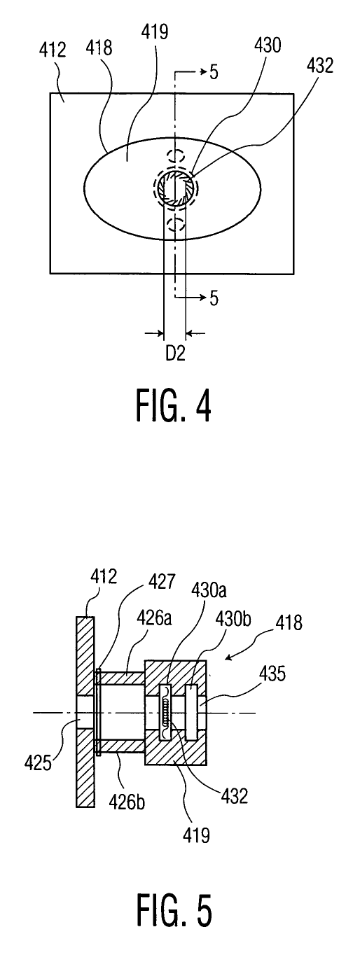

FIGS. 4 and 5 illustrate an embodiment of the invention particularly for use with an optical connector having a collar thereon. A portion of a sidewall 412 of the housing 12 of FIG. 1 is shown. Sidewall 412 has a port 425 through which an illuminating beam, such as that emitted by the light bulb 10 of FIG. 1B, along the longitudinal axis shown by the dash-dot line of FIG. 5, pass. An optical connector 418 in accordance with an embodiment of the invention is attached to the sidewall 412 and spaced therefrom by two legs 426a and 426b. A reflector 427, with a through hole, is mounted intermediate sidewall 412 and optical connector 418, and has a polished, highly reflective surface opposing sidewall 412. The optical connector 418 has a structure 419 and an interior bore 435, along the longitudinal axis. Optical connector 418 is so positioned by legs 426a, 426b, that interior bore 435 is aligned with the port 425 in the sidewall, such that light passing through port 425 continues through the interior bore 435. Optical connector 418 is illustrated having two channels 430a and 430b, both similar to channel 30 of FIG. 3, although a single channel, or more than two channels, may be provided. A spring member 432, which may be similar to spring member 32 of FIGS. 2 and 3, is positioned in the channel 430a.

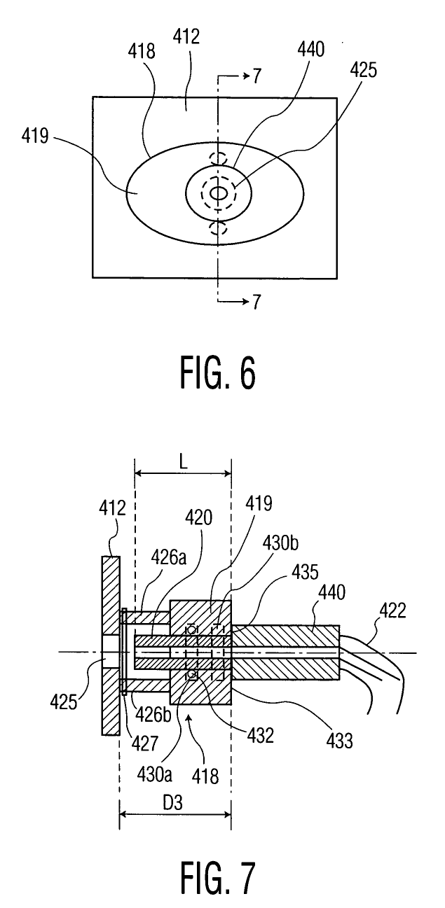

FIGS. 6 and 7 illustrate cylindrical endpiece 420 fully inserted in optical connector 418. In this embodiment, there is no stop in structure 419, but a collar 440 on the cylindrical endpiece prevents the endpiece 20 from moving further in the proximal direction. The inner diameter D2 of spring member 432 (shown in FIG. 4) is slightly smaller than the outer diameter of the cylindrical endpiece 420. Therefore, after insertion of the endpiece 420 into the interior bore 435 from the distal end of the structure 419, endpiece 420 encounters and expands spring member 432, which then exerts a counter force on endpiece 420. After the user exerts sufficient force to urge a leading edge of endpiece 420 past spring member 432, the continued force will typically cause endpiece 420 to move toward wall 412 until collar 440 engages a distal surface 433 of connector 418. The distance D3 between wall 412 and distal surface 433 is greater than length L of endpiece 420 to collar 440, so that endpiece 420 is spaced slightly away from wall 412. Since the threshold level of force required to pull out the endpiece 420 depends at least partially on the compressive force exerted by the spring member 432, the threshold can be elevated by positioning a second spring member 432 in the channel 430b.

In this embodiment, the advantages achieved include providing a secure, yet releasable, optical connection, with optical connector 420 aligned with an illuminating beam and sufficiently close to wall 412 to minimize scattering of the beam before entry into connector 420.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. An optical connector for connecting an optical cable having a cylindrical endpiece, having an outer diameter, to a light source located in a housing having at least one side wall, the wall having at least one port for receiving an illuminating beam from the light source, said optical connector comprising:
a structure having an interior bore along a longitudinal axis, said bore having a first port for receiving an illuminating beam at a proximal end of said bore, a channel situated in said structure transverse to said longitudinal axis, said bore having a second port adapted to receive said cylindrical endpiece at a distal end of said bore, said structure having at least one leg, said bore adapted to be aligned with said port in said sidewall; and
a spring member, positioned in said channel in a circular shape, and an inner diameter of said circular shape being smaller than said outer diameter of said cylindrical endpiece; wherein said spring member is adapted to allow establishment of a secure, yet releasable connection between said endpiece and said spring member;
wherein said structure is attached to said sidewall of said housing via said at least one leg, outside said housing.

2. The optical connector as set forth in claim 1 wherein said bore has a cylindrical surface.

3. The optical connector as set forth in claim 2 wherein said channel is defined in said cylindrical surface.

4. The optical connector as set forth in claim 1 wherein said spring member is a compression coil spring.

5. The optical connector as set forth in claim 1 wherein said spring member comprises elastomeric material.

6. The optical connector as set forth in claim 5 wherein said spring member is substantially cylindrical.

7. A method of connecting an optical cable having a generally cylindrical endpiece, having an outer diameter, to a light source located in a housing having at least one side wall, the side wall having at least one port for receiving an illuminating beam from the light source, comprising the steps of:
providing a structure having at least one leg and an interior bore along a longitudinal axis, said bore having a first port for receiving an illuminating beam at a proximal end of said bore and a second port for receiving said cylindrical endpiece at a distal end of said bore; a channel being defined in said structure transverse to said longitudinal axis;
attaching said structure to said side wall of said housing outside said housing whereby said bore is aligned with said port in said sidewall;
a spring member, having a circular shape, being provided in said channel, an inner diameter of said circular shape being smaller than said outer diameter of said cylindrical endpiece; and
inserting said endpiece in said second port of said bore until a substantially secure, yet releasable, connection is established between said spring member and said endpiece.

8. The method as set forth in claim 7 wherein said spring member is a compression coil spring.

9. The method as set forth in claim 7 wherein said spring member is substantially cylindrical.

10. The method as set forth in claim 9 wherein said spring member is made of elastomeric material.

11. The method as set forth in claim 7, wherein said inserting step comprises:
inserting said endpiece until said endpiece contacts said spring member; and
increasing force on said endpiece to urge a leading edge of said endpiece past said spring member, whereby said endpiece travels until said leading edge engages a stop in said structure, whereby an opening in said endpiece is in alignment with said port.

12. The structure of claim 1, wherein said structure has a smooth outer surface.
